(19) United States
(12) Patent Application Publication
(10) Pub. No.: US 2008/0004394 A1
(43) Pub. Date: Jan. 3, 2008

(54) Method of providing repellency

(76) Inventors: Stefan Reinartz, Wilmington, DE (US); Peter Michael Murphy, Chadds Ford, PA (US); Andrew Joseph McCall, Marlton, NJ (US); Gerald Oronde Brown, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/479,904

(22) Filed: Jun. 30, 2006

(51) Int. Cl. C09D 5/02

(52) U.S. Cl. 524/556

(57) ABSTRACT

A method of providing water repellency, alcohol repellency, oil repellency, and soil resistance to substrates comprising contacting said substrate with a composition comprising a copolymer having repeating units of Formula 1 in any sequence:

[R_{f}(CH₂)ₖOC(O)NH(CH₂)ₖOC(O)C(T)CH₂]ₘ—[W_{q}]ₚ—Formula 1

wherein
R_{f} is a straight or branched perfluoroalkyl group having from about 2 to about 8 carbon atoms, or a mixture thereof, which is optionally interrupted by at least one oxygen atom,
each k is independently a positive integer from 1 to about 6,
T is hydrogen or methyl,
m is a positive integer,
q is zero or a positive integer,
p is zero or a positive integer, and
W is

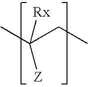

or

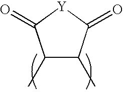

or —[R¹—X—Y—C(O)—CZ-CH₂]—,
wherein
X is an organic divalent linking group having from about 1 to about 20 carbon atoms, optionally containing a triazole, oxygen, nitrogen, or sulfur, or a combination thereof,
Y is O or N(R) wherein R is H or C₁ to C₂₀ alkyl,
Z is H, a straight or branched alkyl group having from about 1 to about 4 carbon atoms, or halide,
Rx is C(O)O(R¹), C(O)N(R²)₂, OC(O)(R¹), SO₂(R¹), C₆(R³)_{g}H_{(5-g)}, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to about 40,
R⁴ is H or CₛH₂ₛ₊₁,
s=0 to about 40,
i=1 to about 200,
each R² is independently H, or CₜH₂ₜ₊₁ wherein t is 1 to 20,
each R³ is independently R⁴, COOR¹, halogen, N(R¹)₂, OR¹, SO₂NHR¹, CH═CH₂, or SO₃M,
g is 1 to 5, and
M is H, alkali metal salt, alkaline earth metal salt, or ammonium.

### FIELD OF THE INVENTION

The present invention relates to a method of treating substrates with fluorinated urethane (meth)acrylate copolymers which impart oil repellency, alcohol repellency, water repellency and soil resistance to the treated substrates.

### BACKGROUND OF THE INVENTION

Various fluorinated polymer compositions are known to be useful as treating agents to provide surface effects to substrates. Many commercially available fluorinated polymers useful as treating agents for imparting repellency to substrates contain perfluoroalkyl groups having predominantly eight or more carbons in the perfluoroalkyl chain to provide the desired repellency properties. It is desirable to reduce the chain length of the perfluoroalkyl groups thereby reducing the amount of fluorine present, while still achieving the desired surface effects.

U.S. Pat. No. 5,256,731 discloses a polymer based on ethylenically unsaturated urethane derivatives wherein the urethane group is substituted on its carboxyl radical with a fluorinated group containing 1 to 12 carbons, and on its nitrogen with an unfluorinated ethylenically unsaturated radical. The polymer is used as a starting material for production of films, sheets, fibers, and other items.

However, poly(fluoroalkylacrylate)s with short fluoroalkyl groups of less than or equal to six carbons usually have poor dynamic water repellency because of the absence of highly ordered fluoroalkyl chains at the outermost surfaces, according to Koji Honda et al., “Molecular Aggregation Structure and Surface Properties of poly(fluoroalkylacrylate) Thin Films” Macromolecules (2005), 38(13), 5699-5705. This suggests performance repellency in treated substrates decreases as chain length of the fluoroalkyl decreases.

There is a need for a method of treating fibrous substrates with polymer compositions which significantly improve their repellency and soil resistance while using lower levels of fluorine. The present invention provides such a method.

### SUMMARY OF THE INVENTION

The present invention comprises a method of providing water repellency, alcohol repellency, oil repellency and soil resistance to substrates comprising contacting said substrate with a composition comprising a copolymer having repeating units of Formula 1 in any sequence:

[R_{f}(CH₂)ₖOC(O)NH(CH₂)ₖOC(O)C(T)CH₂]ₘ—[W_{q}]ₚ— Formula 1

wherein

R_{f} is a straight or branched perfluoroalkyl group having from about 2 to about 8 carbon atoms, or a mixture thereof, which is optionally interrupted by at least one oxygen atom,

each k is independently a positive integer from 1 to about 6,

T is hydrogen or methyl,

m is a positive integer,

q is zero or a positive integer,

p is zero or a positive integer, and

W is

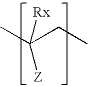

or

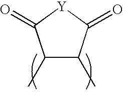

or —[R¹—X—Y—C(O)—CZ-CH₂]—,
wherein

X is an organic divalent linking group having from about 1 to about 20 carbon atoms, optionally containing a triazole, oxygen, nitrogen, or sulfur, or a combination thereof,

Y is O or N(R) wherein R is H or C₁ to C₂₀ alkyl,

Z is H, a straight or branched alkyl group having from about 1 to about 4 carbon atoms, or halide,

Rx is C(O)O(R¹), C(O)N(R²)₂, OC(O)(R¹), SO₂(R¹), C₆(R³)_{g}H_{(5-g)}, O(R¹), halide, or R¹;

each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,

n is 1 to about 40,

R⁴ is H or CₛH₂ₛ₊₁,

s=0 to about 40,

i=1 to about 200,

each R² is independently H, or CₜH₂ₜ₊₁ wherein t is 1 to 20,

each R³ is independently R⁴, COOR¹, halogen, N(R¹)₂, OR¹, SO₂NHR¹, CH═CH₂, or SO₃M,

g is 1 to 5, and

M is H, alkali metal salt, alkaline earth metal salt, or ammonium.

The present invention further comprises substrates treated with a composition of Formula 1 described above having water repellency, alcohol repellency, oil repellency and soil resistance.

### DETAILED DESCRIPTION OF THE INVENTION

All trademarks are denoted herein by capitalization. In all instances herein, the term “(meth)acrylate” is used to denote either or both acrylate or methacrylate.

The present invention comprises a method of treating substrates with fluorinated urethane (meth)acrylate copolymers which have improved fluorine efficiency due to use of shorter chain length of the perfluoroalkyl groups in the copolymer. By “fluorine efficiency” is meant the ability to use a minimum amount of fluorine to obtain the desired surface effect, such as repellency properties, when applied to substrates, or to obtain better performance using the same level of fluorine. A copolymer having high fluorine efficiency generates the same or greater level of surface effect using a lower amount of fluorine than a comparative copolymer.

The copolymers used in the method of the present invention comprise repeating units of Formula 1 in any sequence. Polymer sequence includes random, statistical, block, multiblock, gradient, or alternating. Formula I is

[R_{f}(CH₂)ₖOC(O)NH(CH₂)ₖOC(O)C(T)CH₂]ₘ—[W_{q}]ₚ— Formula 1

wherein

R_{f} is a straight or branched perfluoroalkyl group having from about 2 to about 8 carbon atoms, or a mixture thereof, which is optionally interrupted by at least one oxygen atom,

each k is independently a positive integer from 1 to about 6,

T is hydrogen or methyl,

m is a positive integer,

q is zero or a positive integer,

p is zero or a positive integer, and

W is

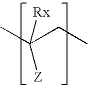

or

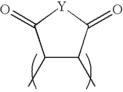

or —[R¹—X—Y—C(O)—CZ-CH₂]—,
wherein

X is an organic divalent linking group having from about 1 to about 20 carbon atoms, optionally containing a triazole, oxygen, nitrogen, or sulfur, or a combination thereof,

Y is O, S or N(R) wherein R is H or C₁ to C₂₀ alkyl,

Z is H, a straight or branched alkyl group having from about 1 to about 4 carbon atoms, or halide,

Rx is C(O)O(R¹), C(O)N(R²)₂, OC(O)(R¹), SO₂(R¹), C₆(R³)_{g}H_{(5-g)}, O(R¹), halide, or R¹;

each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,

n is 1 to about 40,

R⁴ is H or CₛH₂ₛ₊₁,

s=0 to about 40,

i=1 to about 200,

each R² is independently H, or CₜH₂ₜ₊₁ wherein t is 1 to 20,

each R³ is independently R⁴, COOR¹, halogen, N(R¹)₂, OR¹, SO₂NHR¹, CH═CH₂, or SO₃M,

g is 1 to 5, and

M is H, alkali metal salt, alkaline earth metal salt, or ammonium.

In Formula 1, R_{f} is preferably a straight or branched perfluoroalkyl group having from about 2 to 8 carbon atoms, or a mixture thereof, more preferably from about 4 to about 6 carbon atoms, or a mixture thereof, optionally interrupted by at least one oxygen atom. Most preferably, the perfluoroalkyl group has six carbon atoms.

In Formula 1, m is preferably from 0 to about 10,000, more preferably from about 5 to about 2000, or a mixture thereof; p is preferably from 1 to about 10,000, more preferably from about 5 to about 2000, or a mixture thereof; and q is preferably from 0 to about 100, more preferably from 0 to about 20, or a mixture thereof.

Examples of preferred group W are methacrylic acid, alkyl methacrylate ester, vinylidene chloride, and styrene.

Examples of suitable linking groups X include straight chain, branched chain or cyclic alkylene, phenyl, arylene, aralkylene, sulfonyl, sulfoxy, sulfonamido, carbonamido, carbonyloxy, urethanylene, ureylene, and combinations thereof such as sulfonamidoalkylene.

Examples of preferred groups Y are O, S or N(R)₂ wherein R is H or C₁ to C₄ alkyl;

The copolymers are prepared by polymerization of fluorinated urethane(meth)acrylic monomers with other monomers such as alkyl(meth)acrylate, vinylidene chloride, acrylamide, styrene, ethyl undecylenate and the like. For example, the copolymers of Formula 1 are prepared by reacting a monomer with a fluorinated urethane(meth)acrylate of Formula 2:

R_{f}(CH₂)ₖOC(O)NH(CH₂)ₖOC(O)C(T)=CH₂ Formula 2

wherein

R_{f}, k and T are each defined as for Formula 1 above.

The fluorinated urethane(meth)acrylate monomer of Formula 2, used in the preparation of the copolymer of Formula 1, is prepared by reacting perfluoroalkylethanol with a (meth)acrylate having a reactive isocyanate group and a polymerizable vinyl double bond. The preferred conditions for the reaction are at a temperature of from about −10° C. to about 60° C. Suitable optional solvents include tetrahydrofuran, methyl isobutyl ketone, acetone, hexane or ethyl acetate.

The fluorinated urethane(meth)acrylic monomer of Formula 2 is then polymerized with other monomers such as nonfluorinated (meth)acrylate, fluorinated(meth)acrylate, vinylidene chloride, acrylamide, styrene, ethyl undecylenate and the like to prepare the copolymer of Formula 1.

The nonfluorinated(meth)acrylate monomers suitable for use in the preparation of the copolymer of Formula 1 used in the method of the present invention comprise alkyl(meth)acrylates in which the alkyl group is a straight or branched chain containing 1 to 20 carbon atoms, or mixtures thereof, preferably 8 to 18 carbon atoms. The C₂-C₂₀ alkyl(meth)acrylates (linear or branched) are exemplified by, but not limited to, alkyl(meth)acrylates where the alkyl group is methyl, ethyl, propyl, butyl, isoamyl, hexyl, cyclohexyl, octyl, 2-ethylhexyl, decyl, isodecyl, lauryl, cetyl, or stearyl. The preferred examples are 2-ethylhexyl acrylate, lauryl acrylate and stearyl acrylate.

Additional optional monomers can also be used in the polymerization reaction to prepare the copolymers of Formula 1 containing additional repeating units. These optional monomers include N-methylol(meth)acrylates, hydroxyalkyl(meth)acrylates, alkyloxy(meth)acrylates, fluorinated(meth)acrylates, glycidyl(meth)acrylates, stearyl acrylate, aminoalkyl methacrylate hydrochloride, acrylamide, alkyl acrylamide, vinyl acetate, vinyl stearate, alkyl vinyl sulfone, styrene, vinyl benzoic acid, alkyl vinyl ether, maleic anhydride, vinylidene chloride, vinyl chloride, and other olefin.

Optional N-methylol monomers are exemplified by, but not limited to N-methylolacrylamide and N-methylolmethacrylamide. The optional hydroxyalkyl(meth)acrylates have alkyl chain lengths in the range between 2 and 4 carbon atoms, and are exemplified by 2-hydroxyethyl acrylate, and 2-hydroxyethyl methacrylate. The optional alkyloxy(meth)acrylates also have alkyl chain lengths in the range between 2 and 4 carbon atoms, and contain between 1 and 12 oxyalkylene units per molecule, preferably between 4 and 10 oxyalkylene units per molecule, and most preferably between 6 and 8 oxyalkylene units per molecule, as determined by gas chromatography/mass spectrometry. Specific examples of the poly(oxyalkylene)(meth)acrylates are exemplified by, but not limited to, the reaction product of 2-hydroxyethyl methacrylate and ethylene oxide. The reaction with nine moles of ethylene oxide yields 2-hydroxyethyl methacrylate/9-ethylene oxide adduct, and the reaction with six moles of ethylene oxide yields 2-hydroxyethyl methacrylate/6-ethylene oxide adduct. Other suitable optional nonfluorinated monomers are styrene, maleic anhydride, and vinylidene chloride. When such optional monomers are present, polymerization processes employed are conventional ones known to those skilled in the art.

The fluorinated urethane(meth)acrylate copolymers of Formula 1 are prepared in organic solvent or water with one or more surfactants by free radical initiated polymerization of a mixture of fluorinated urethane(meth)acrylic monomers of Formula 2 with any of other monomers listed above. The fluorinated copolymers of this invention are made by agitating the monomers described above in organic solvent or water with one or more surfactants in a suitable reaction vessel which is equipped with an agitation device and an external heating and cooling device. The ratio of fluorinated monomer of Formula 2 to other monomer is at least 0.1 to 1, preferably at least 0.5 to 1, more preferably at least 1 to 1, and more preferably at least 2 to 1 or greater. A free radical initiator is added and the temperature raised to from about 20° to about 70° C. The polymerization initiator is exemplified by 2,2′-azobis(2-amidinopropane dihydrochloride or 2,2′-azobis(isobutyramidine)dihydrochloride. These initiators are sold by E. I. du Pont de Nemours and Company, Wilmington, Del., commercially under the name of “VAZO”. An example of a suitable polymerization regulator or chain transfer agent is dodecylmercaptan. Suitable organic solvents useful in the preparation of the copolymers of Formula 1 of the present invention include tetrahydrofuran, acetone, methyl isobutyl ketone, isopropanol, ethyl acetate, and mixtures thereof. Tetrahydrofuran is preferred. The reaction is conducted under an inert gas, such as nitrogen, to the exclusion of oxygen. The polymer is optionally isolated by precipitation, and optionally purified by, for example, recrystallization. The solvent is removed by evaporation, or the solution is retained for dilution and application to the substrate. The product of the reaction is a fluorinated urethane (meth)acrylate copolymer of Formula 1.

The resulting fluorinated urethane(meth)acrylate copolymer of Formula 1 then is applied to a substrate, or is diluted with water, or further dispersed or dissolved in a solvent selected from the groups comprising simple alcohols and ketones that are suitable as the solvent for final application to substrates (hereinafter the “application solvent”).

Alternatively, an aqueous dispersion, made by conventional methods with surfactants, is prepared by removing solvents by evaporation and the use of emulsification or homogenization procedures known to those skilled in the art. Such solvent-free emulsions are preferred to minimize flammability and volatile organic compounds (VOC) concerns.

The final product for application to a substrate is a dispersion (if water based) or a solution (if a solvent other than water is used) of the fluorinated urethane (meth)acrylate copolymer of Formula 1.

The present invention comprises a method of providing oil repellency, water repellency, alcohol repellency, or soil resistance to a substrate comprising contacting the fluorinated urethane(meth)acrylate copolymer solution or dispersion of Formula I as described above with the substrate. Suitable substrates include fibrous substrates as defined below.

The fluorinated urethane(meth)acrylate copolymer solution or dispersion is applied to the substrate by any suitable method. Such methods include, but are not limited to, application by exhaustion, foam, flex-nip, nip, pad, kiss-roll, beck, skein, winch, liquid injection, overflow flood, roll, brush, roller, spray, dipping, immersion, and the like. It is also applied by use of beck dyeing procedure, continuous dyeing procedure or thread-line application.

The fluorinated urethane(meth)acrylate copolymer solution or dispersion is applied to the substrate as such, or in combination with other optional textile finishes or surface treating agents.

Such optional additional components include treating agents or finishes to achieve additional surface effects, or additives commonly used with such agents or finishes. Such additional components comprise compounds or compositions that provide surface effects such as no iron, easy to iron, shrinkage control, wrinkle free, permanent press, moisture control, softness, strength, anti-slip, anti-static, anti-snag, anti-pill, stain repellency, stain release, soil repellency, soil release, water repellency, oil repellency, odor control, antimicrobial, sun protection, cleanability and similar effects. One or more of such treating agents or finishes are applied to the substrate before, after, or simultaneously with the copolymer of Formula I. For example for fibrous substrates, when synthetic or cotton fabrics are treated, use of a wetting agent can be desirable, such as ALKANOL 6112 available from E. I. du Pont de Nemours and Company, Wilmington, Del. When cotton or cotton-blended fabrics are treated, a wrinkle-resistant resin can be used such as PERMAFRESH EFC available from Omnova Solutions, Chester, S.C.

Other additives commonly used with such treating agents or finishes are also optionally present such as surfactants, pH adjusters, cross linkers, wetting agents, wax extenders, and other additives known by those skilled in the art.

Suitable surfactants include anionic, cationic, nonionic, N-oxides and amphoteric surfactants. Preferred is an anionic surfactant such as sodium lauryl sulfate, available as DUPONOL WAQE or SUPRALATE WAQE from Witco Corporation, Greenwich, Conn., or SUPRALATE WAQE available from Witco, Houston Tex. Examples of such additives include processing aids, foaming agents, lubricants, anti-stains, and the like. The composition is applied at a manufacturing facility, retailer location, or prior to installation and use, or at a consumer location.

Application rates for the fluorinated urethane (meth)acrylate copolymer solution or dispersion of Formula 1 of the present invention depend on the substrate porosity. A treated fibrous substrate typically has fluorine content of from about 100 micrograms per gram to about 10,000 micrograms per gram by weight. Preferably the fluorine content is from about 1,000 micrograms per gram to about 4,000 micrograms per gram.

Optionally a blocked isocyanate to further promote durability is added with the composition of Formula 1 (i.e., as a blended isocyanate). An example of a suitable blocked isocyanate to use in the present invention is HYDROPHOBOL XAN available from Ciba Specialty Chemicals, High Point, N.J. Other commercially available blocked isocyanates are also suitable for use herein. The desirability of adding a blocked isocyanate depends on the particular application for the copolymer. For most of the presently envisioned applications, it does not need to be present to achieve satisfactory cross-linking between chains or bonding to the substrate. When added as a blended isocyanate, amounts up to about 20% by weight are added.

Optionally, nonfluorinated extender compositions are also included in the application composition to potentially further increase fluorine efficiency. Examples of such optional additional extender polymer compositions are those disclosed in co-pending US Patent Application 2006/0052556A1, filed Jul. 6, 2005 (CH2996), and in U.S. Ser. No. 11/175680 filed Jul. 6, 2005 (CH3048).

The optimal repellent treatment for a given substrate depends on (1) the characteristics of the fluorinated copolymer, (2) the characteristics of the surface of the substrate, (3) the amount of fluorinated copolymer applied to the surface, (4) the method of application of the fluorinated copolymer onto the surface, and many other factors. Some fluorinated copolymer repellents work well on many different substrates and are repellent to oil, water, and a wide range of other liquids. Other fluorinated copolymer repellents exhibit superior repellency on some substrates or require higher loading levels.

The present invention also comprises substrates treated with the fluorinated urethane (meth)acrylate copolymer solution or dispersion of Formula 1 as described above. Suitable substrates include fibrous substrates. The fibrous substrates include fibers, yarns, fabrics, fabric blends, textiles, nonwovens, paper, leather, and carpets. These are made from natural or synthetic fibers including cotton, cellulose, wool, silk, rayon, nylon, aramid, acetate, acrylic, jute, sisal, sea grass, coir, polyamide, polyester, polyolefin, polyacrylonitrile, polypropylene, polyaramid, or blends thereof. By “fabric blends” is meant fabric made of two or more types of fibers. Typically these blends are a combination of at least one natural fiber and at least one synthetic fiber, but also can include a blend of two or more natural fibers or of two or more synthetic fibers. The nonwoven substrates include, for example, spunlaced nonwovens, such as SONTARA available from E. I. du Pont de Nemours and Company, Wilmington, Del., and spunbonded-meltblown-spunbonded nonwovens, The treated substrates of the present invention have excellent water repellency, oil repellency, alcohol repellency and soil resistance. However, the spunbonded-meltblown-spunbonded nonwovens, such as made from polypropylene, have good inherent water and alcohol repellency when untreated.

The method of the present invention is useful to provide one or more of excellent water repellency, alcohol repellency, oil repellency, and soil resistance to treated substrates. The fluorinated urethane(meth)acrylate copolymers used in the method of the present invention allow for the use of shorter fluoroalkyl groups containing from about 2 to about 8 carbon atoms and thus have greater fluorine efficiency. Conventional commercially available (meth)acrylates typically show poor oil repellency and water repellency performance if the fluoroalkyl groups contain less than 8 carbon atoms. The treated substrates of the present invention are useful in a variety of applications and products such as clothing, protective garments, carpet, upholstery, furnishings, and other uses. The excellent repellency properties help to maintain surface cleanliness and therefore can permit longer use.

### Test Methods

### Test Method 1

The fabric was treated with the copolymer dispersion for emulsion padding application using a pad bath (dipping) process. A bath containing 0.2 to 2% of the fluorinated product, as detailed in the Tables in the Examples, was used to treat fabric substrates, often in combination with a blocked extender and/or a softener as specified in the tests. A wetting agent was also included. After application, the fabric was dried. The fabric was allowed to cool down to room temperature after treatment and cure.

The fabric was treated with the fluorinated urethane copolymer prepared according to the procedure described in the Examples. The fluorinated urethane copolymers were applied to various substrates including 100% cotton textile fabric, 100% nylon textile fabric, spunbonded meltdown spunbonded polypropylene (SMS PP) nonwoven fabric, and SONTARA nonwoven fabric. The fabrics were cut into square pieces of approximately 12 inches by 12 inches (30.5 cm by 30.5 cm). The copolymers prepared according to the procedures described in Examples were diluted in tetrahydrofuran and were applied to the fabric using a dropping pipette. The number of drops applied to the fabric just saturated the fabric. The concentrations of the fluorinated urethane copolymer in the tetrahydrofuran solutions were adjusted to achieve the goal application level of fluorine on fabric. After application, the fabric was allowed to air dry for at least 18 hours. The fabrics were tested for water repellency and oil repellency using Test Methods 2 and 3 as described below.

### Test Method 2—Isopropyl Alcohol/Water Repellency

The alcohol and water repellency of a treated substrate was measured according to AATCC standard Test Method No. 193-2004 and the DuPont Technical Laboratory Method as outlined in the TEFLON Global Specifications and Quality Control Tests information packet. The test determines the resistance of a treated substrate to wetting by aqueous liquids. Drops of water-alcohol mixtures of varying surface tensions are placed on the substrate and the extent of surface wetting is determined visually.

The composition of water repellency test liquids is shown in table 1.

TABLE 1

| Water | Composition, | Composition, |
|---|---|---|
| Repellency | Volume % | Volume % |
| Rating Number | Isopropyl Alcohol | Distilled Water |
| 1 | 2 | 98 |
| 2 | 5 | 95 |
| 3 | 10 | 90 |
| 4 | 20 | 80 |
| 5 | 30 | 70 |
| 6 | 40 | 60 |
| 7 | 50 | 50 |
| 8 | 60 | 40 |
| 9 | 70 | 30 |
| 10 | 80 | 20 |
| 11 | 90 | 10 |
| 12 | 100 | 0 |

Three drops of Test Liquid 1 are placed on the treated substrate. After 10 seconds, the drops are removed by using vacuum aspiration. If no liquid penetration or partial absorption (appearance of a darker wet patch on the substrate) is observed, the test is repeated with Test Liquid 2. The test is repeated with Test Liquid 3 and progressively higher Test Liquid numbers until liquid penetration (appearance of a darker wet patch on the substrate) is observed. The test result is the highest Test Liquid number that does not penetrate into the substrate. Higher scores indicate greater repellency.

### Test Method 3—Oil Repellency

The treated fabric samples were tested for oil repellency by a modification of AATCC standard Test Method No. 118, conducted as follows. A fabric sample, treated with an aqueous dispersion of polymer as previously described, is maintained for a minimum of 2 hours at 23° C.+20% relative humidity and 65° C.+10% relative humidity. A series of organic liquids, identified below in Table 2, are then applied dropwise to the fabric samples. Beginning with the lowest numbered test liquid (Repellency Rating No. 1), one drop (approximately 5 mm in diameter or 0.05 mL volume) is placed on each of three locations at least 5 mm apart. The drops are observed for 30 seconds. If, at the end of this period, two of the three drops are still spherical in shape with no wicking around the drops, three drops of the next highest numbered liquid are placed on adjacent sites and similarly observed for 30 seconds. The procedure is continued until one of the test liquids results in two of the three drops failing to remain spherical to hemispherical, or wetting or wicking occurs.

The oil repellency rating of the fabric is the highest numbered test liquid for which two of the three drops remained spherical to hemispherical, with no wicking for 30 seconds. In general, treated fabrics with a rating of 5 or more are considered good to excellent; fabrics having a rating of one or greater can be used in certain applications.

TABLE 2
Oil Repellency Test Liquids

| Oil Repellency | |
|---|---|
| Rating Number | Test Solution |
| 1 | NUJOL Purified Mineral Oil |
| 2 | 65/35 Nujol/n-hexadecane by volume at 21° C. |
| 3 | n-hexadecane |
| 4 | n-tetradecane |
| 5 | n-dodecane |
| 6 | n-decane |
| 7 | n-octane |
| 8 | n-heptane |

Note:
NUJOL is a trademark of Plough, Inc., for a mineral oil having a Saybolt viscosity of 360/390 at 38° C. and a specific gravity of 0.880/0.900 at 15° C.

### Test Method 4—Accelerated Soiling Test

A drum mill (on rollers) was used to tumble synthetic soil onto carpet samples. Synthetic soil was prepared as described in AATCC Test Method 123-2000, Section 8. Soil-coated beads were prepared as follows. Synthetic soil, 3 g, and 1 liter of clean nylon resin beads (SURLYN ionomer resin beads ⅛− 3/16 inch (0.32-0.48 cm) diameter were placed into a clean, empty canister. SURLYN is an ethylene/methacrylic acid copolymer, available from E. I. du Pont de Nemours and Co., Wilmington Del.). The canister lid was closed and sealed with duct tape and the canister rotated on rollers for 5 minutes. The soil-coated beads were removed from the canister.

Carpet samples to insert into the drum were prepared as follows. Total carpet sample size was 8×25 inch (20.3×63.5 cm) for these tests. One test sample and one control sample were tested at the same time. The carpet pile of all samples was laid in the same direction. The shorter side of each carpet sample was cut in the machine direction (with the tuft rows). Strong adhesive tape was placed on the backside of the carpet pieces to hold them together. The carpet samples were placed in the clean, empty drum mill with the tufts facing toward the center of the drum. The carpet was held in place in the drum mill with rigid wires. Soil-coated resin beads, 250 cc, and 250 cc of ball bearings ( 5/16 inch, 0.79 cm diameter) were placed into the drum mill. The drum mill lid was closed and sealed with duct tape. The drum was run on the rollers for 2½ minutes at 105 rpm. The rollers were stopped and the direction of the drum mill reversed. The drum was run on the rollers for an additional 2½ minutes at 105 rpm. The carpet samples were removed and vacuumed uniformly to remove excess dirt. The soil-coated beads were discarded.

The Delta E color difference for the soiled carpet was measured for the test and control items versus the original unsoiled carpet. Color measurement of each carpet was conducted on the carpet following the accelerated soiling test. For each control and test sample the color of the carpet was measured, the sample was soiled, and the color of the soiled carpet was measured. The Delta E is the difference between the color of the soiled and unsoiled samples, expressed as a positive number. The color difference was measured on each item, using a Minolta Chroma Meter CR-310. Color readings were taken at five different areas on the carpet sample, and the average Delta E was recorded. The control carpet for each test item was of the same color and construction as the test item. The control carpet had not been treated with any fluorochemical.

The percentage of soil blocked after drum soil as “% soil blocked after drum soil” was calculated by following calculations:

$$\% soil blocked after drum soil = \frac{[ \begin{matrix}( Delta E of soiled untreated carpet ) - \\ ( Delta E of soiled treated carpet )\end{matrix} ]}{( Delta E of soiled untreated carpet )} \times 100 \%$$

### EXAMPLES

For all Tables in the Examples section, measured fluorine is the weight ratio of fluorine to the weight of the entire treated fabric or carpet unless specified otherwise. Monomers A, B and C used in the Examples were prepared as follows.

### Monomer A

To a four-neck 1000 mL round bottom flask fitted with overhead stirrer, 2 addition funnels, thermocouple, and nitrogen flow system, was added 3,3,4,4,5,5,6,6,7,7,8,8,8-tridecafluoro-1-octanol (81.1 g, 0.223 mol, 1.05 eq.) and dry hexane (175 mL). After cooling to −10° C., 2-isocyanatoethylmethacrylate, purchased from Sigma-Aldrich, (30 mL, 0.212 mol, 1.0 eq) in dry hexane (175 mL) was added dropwise, maintaining a temperature of less than 0° C. Then, dibutyltin dilaurate (1.0 mL, 0.0017 mol, 0.008 eq) in dry hexanes (35 mL) was added dropwise, maintaining a temperature of less than 0° C. The reaction was permitted to warm to room temperature (approx. 20° C.). A clear, colorless solution was obtained. A sample was removed for GC and LC/MS (API-ES+) at 1 hour. The GC showed no starting material 3,3,4,4,5,5,6,6,7,7,8,8,8-tridecafluoro-1-octanol. LC/MS showed the presence of the desired product of 2-propenoic acid, 2-methyl-, 2-[[[(3,3,4,4,5,5,6,6,7,7,8,8,8-tridecafluorooctyl)oxy]carbonyl]amino]ethyl ester (M+H and M+Na). After 2 hours, the reaction mixture was cooled to −10° C. to precipitate the product. The slurry was stirred for 30 minutes and subsequently filtered through a medium frit. The isolated solid was rinsed with a small amount of cold hexane and dried under a nitrogen bonnet. Midway through the drying process, the solid was ground by mortar and pestle to facilitate drying and break up the large pieces. 100.8 g (92%) of the product of 2-propenoic acid, 2-methyl-, 2-[[[(3,3,4,4,5,5,6,6,7,7,8,8,8-tridecafluorooctyl)oxy]carbonyl]amino]ethyl ester was obtained after drying to constant weight as a waxy white solid, melting at 35-36° C. NMR (1H, 13C, and 19F-NMR in CDCl3), LC/MS (API-ES+), and (APCI+) confirmed the desired product. GC showed only 1 peak.

### Monomer B

The reaction was conducted using the procedure of Monomer A, and 2-isocyanatoethylmethacrylate and 3,3,4,4,5,5,6,6,6-nonafluoro-1-hexanol, instead of 3,3,4,4,5,5,6,6,7,7,8,8,8-tridecafluoro-1-octanol. The product generated was 2-Propenoic acid, 2-methyl-, 2-[[[(3,3,4,4,5,5,6,6,6-nonafluorohexyl)oxy]carbonyl]amino]ethyl ester in 81% yield.

### Monomer C

The reaction was conducted using the procedure of Monomer A, and 2-isocyanatoethylmethacrylate and 3,3,4,4,5,5,6,6,7,7,8,8,9,9,10,10,10-heptadecafluoro-1-decanol, instead of 3,3,4,4,5,5,6,6,7,7,8,8,8-tridecafluoro-1-octanol. The product generated was 2-propenoic acid, 2-methyl-, 2-[[[(3,3,4,4,5,5,6,6,7,7,8,8,9,9,10,10,10-heptadecafluorodecyl)oxy]carbonyl]amino]ethyl ester in 92% yield.

### Example 1

In a four-neck 500 mL round bottom flask fitted with a condenser, mechanical stirrer, gas inlet, and gas outlet was added Monomer A (4.20 grams, 0.00809 moles), stearyl acrylate (1.31 grams, 0.00405 moles), dodecyl mercaptan (0.30 grams), VAZO 67 (0.75 grams), and THF (95 grams). While stirring at 20° C. for one hour, dry nitrogen was gently bubbled through the solution to remove any oxygen. The nitrogen bubbling was replaced with a blanket of nitrogen and the reaction mixture was heated to 70° C. with stirring for 12 hours. After cooling, the reaction mixture was analyzed by gas chromatography to confirm that greater than 95% of the monomers were polymerized. The copolymer solution was applied using Test Method 1 to fabrics as described in Example 2-18 without further characterization. The treated fabrics were tested for water repellency and oil repellency using Test Methods 2 and 3. The results are listed in Table 4.

### Examples 2-25

For each Example from Example 2 to Example 25, the copolymers listed in Table 3 were prepared using the procedure of Example 1. The resulted copolymer examples 2-18 were each applied using Test Method 1 to various fabrics described below in Table 4 from a tetrahydrofuran solution with final loading of about 4000 micrograms per gram fluorine by weight. The cotton fabric used in the test was a woven cotton fabric, dyed but not finished, manufactured by Avondale Mills (Warrenville, S.C.) with a fabric weight of 210 grams/square meter. The nylon fabric used in the test was a woven nylon fabric, dyed but not finished, manufactured by Avondale Mills (Warrenville, S.C.) with a fabric weight of 76 grams/square meter. The nonwoven fabric used in the test was a nonwoven spunbonded-meltblown-spunbonded polypropylene fabric (SMS PP) manufactured by Kimberly-Clark (Roswell, Ga.) with a fabric weight of 39 grams/square meter. The SONTARA fabric with a fabric weight of 80 grams/square meter was a spunlaced polyester-cellulosic manufactured by E. I. du Pont de Nemours and Company (Nashville, Tenn.). The treated fabrics were tested for water repellency and oil repellency using Test Methods 2 and 3. The results are in Table 4.

TABLE 3

| | Monomer B | Monomer A | Monomer C | Co-monomers | |
|---|---|---|---|---|---|
| Example | (gram) | (gram) | (gram) | Name | (gram) |
| Example 2 | | 4.20 | | diethylaminoethyl m | 0.75 |
| Example 3 | | 4.20 | | 2-ethylhexyl | 0.80 |
| | | | | methacrylate | |
| Example 4 | | 4.20 | | vinyl chloride | 0.39 |
| | | | | stearyl acrylate | 1.31 |
| Example 5 | | 4.20 | | butyl methacrylate | 1.21 |
| Example 6 | | 4.20 | | acrylamide | 0.29 |
| Example 7 | | 4.20 | | lauryl | 1.14 |
| | | | | methacrylate | |
| Example 8 | | 4.20 | | glycidyl | 0.57 |
| | | | | methacrylate | |
| | | | | stearyl acrylate | 1.31 |
| Example 9 | | | 3.83 | stearyl acrylate | 1.41 |
| Example 10 | 4.90 | | | stearyl acrylate | 1.90 |
| Example 11 | | 1.92 | 2.10 | stearyl acrylate | 1.31 |
| Example 12 | | | 0.21 | stearyl acrylate | 1.31 |
| Example 13 | | | 4.31 | stearyl acrylate | 0.33 |
| Example 14 | | | 3.38 | Styrene | 0.42 |
| Example 15 | | | 3.38 | hydroxybutyl | 0.64 |
| | | | | methacrylate | |
| Example 16 | | | 3.38 | ethyl undecylenate | 0.86 |
| Example 17 | | | 3.38 | methacrylic acid | 0.35 |
| Example 18 | | | 3.38 | ethylene glycol | 0.85 |
| | | | | methacrylate | |
| | | | | phosphate | |
| Example 19 | | 4.20 | | vinyl stearate | 1.20 |
| Example 20 | | 4.20 | | stearyl | 1.37 |
| | | | | methacrylate | |
| Example 21 | | 4.20 | | vinyl acetate | 0.35 |
| Example 22 | | 4.20 | | ethyl vinyl ether | 0.29 |
| Example 23 | | 8.40 | | methyl | 1.62 |
| | | | | methacrylate | |
| Example 24 | 4.90 | | | stearyl | 1.37 |
| | | | | methacrylate | |
| Example 25 | 2.45 | 2.10 | | stearyl acrylate | 1.31 |

TABLE 4

| | IPA*/Water | | | | | | |
|---|---|---|---|---|---|---|---|
| | Repellency | | | Oil Repellency | | | |
| Example | Cotton | Nylon | SONTARA | Cotton | Nylon | SMS PP* | SONTARA |
| 1 | 4 | 4 | 5 | 3 | 3 | 2 | 5 |
| 2 | 5 | 4 | 4 | 5 | 4 | 3 | 6 |
| 3 | 4 | 4 | 3 | 5 | 3 | 1 | 6 |
| 4 | 5 | 5 | 5 | 4 | 2 | 2 | 5 |
| 5 | 5 | 4 | 4 | 5 | 3 | 2 | 6 |
| 6 | 5 | 4 | 4 | 6 | 4 | 5 | 6 |
| 7 | 4 | 4 | 4 | 3 | 2 | 1 | 4 |
| 8 | 5 | 5 | 5 | 4 | 2 | 2 | 4 |
| 9 | | | | | | 5 | |
| 10 | | | | | | 4 | |
| 11 | | | | | | 4 | |
| 12 | | | | | | 0 | |
| 13 | | | | | | 5 | |
| 14 | | | | | | 6 | |
| 15 | | | | | | 6 | |
| 16 | | | | | | 5 | |
| 17 | | | | | | 6 | |
| 18 | | | | | | 6 | |
| 19 | 5 | 4.5 | 4.5 | 6 | 2 | 4.5 | 6 |
| 20 | 4.5 | 3 | 4 | 5 | 0.5 | 2.5 | 4.5 |
| 21 | 3.5 | 3 | 1.5 | 6 | 4 | 0.5 | 6 |
| 22 | 5 | 4.5 | 4 | 6 | 5.5 | 4.5 | 6 |
| 23 | 4 | 4 | 3 | 6 | 2 | 2.5 | 6 |
| 24 | 3 | 3 | 0.5 | 2 | 0.5 | 0 | 1 |
| 25 | 4 | 4 | 4 | 4.5 | 0.5 | 2.5 | 4 |
| Untreated | 0 | 0 | 0 | 0 | 0 | 0 | 0 |

*IPA = isopropyl alcohol
+ SMS PP is spunbonded-meltblown-spunbonded polypropylene nonwoven.

The data in Table 4 shows that a wide range of copolymers used in the method of the present invention provide water repellency, alcohol repellency and oil repellency. The copolymers demonstrated good to excellent water/IPA repellency on cotton and nylon textile fabrics and SONTARA spunlaced nonwoven fabric. The copolymers used in the method of the present invention demonstrated good to excellent oil repellency on cotton textile fabrics and SONTARA nonwoven fabric. For nylon all examples improved oil repellency compared to the untreated control. On spunbonded-meltblown-spunbonded polypropylene nonwoven fabric the copolymers used in the present invention improved the oil repellency compared to the untreated control. Example 12 showed poor results for oil repellency on this nonwoven, possibly due to the very low amount of Monomer C employed, while Examples 13 and 14 containing higher levels of monomer C with the same co-monomer demonstrated excellent repellency.

The copolymer of Example 3 in tetrahydrofuran solution was applied to SONTARA fabric at a series of different treatment rates. The results are in Table 5.

TABLE 5
Fluorine Level Series on SONTARA

| | Goal weight | | |
|---|---|---|---|
| | ratio of | | |
| | fluorine to | | |
| | SONTARA | | IPA/Water |
| Example | (ppm*) | Oil Repellency | Repellency |
| 3 | 200 | 4 | 0 |
| 3 | 500 | 5 | 0 |
| 3 | 1000 | 5 | 1 |
| 3 | 2000 | 6 | 3 |
| 3 | 4000 | 6 | 3 |
| 3 | 6000 | 6 | 3 |
| Untreated | 0 | 0 | 0 |

*ppm = microgram per gram

The data in Table 5 shows that the copolymers used in the method of the present invention were effective at relatively low application levels. Example 3 showed significant oil repellency on SONTARA nonwoven fabric between 200 and 6000 ppm fluorine by weight and good IPA/water repellency on SONTARA nonwoven fabric between 2000 and 6000 ppm fluorine by weight.

A commercial carpet of nylon-6,6 four-hole hollowfil INVISTA-ANTRON level loop 28 oz/yd² (0.9 kg/m²)carpet dyed yellow was treated with the copolymers of Examples 17, 21, 22 and 23 and tested for soiling and repellency performance using the Test Methods 2, 3 and 4 as described above. The results are in Table 6.

TABLE 6

| Treated with | | | | % Soil |
|---|---|---|---|---|
| the | | | Measured weight | Blocked |
| Copolymer | IPA/Water | Oil | ratio of fluorine | after |
| of Example | Repellency | Repellency | to fabric (ppm)* | Drum Soil |
| 17 | 2 | 1 | 780 | 28% |
| 23 | 3 | 2 | 130 | 19% |
| 22 | 4 | 4 | 380 | 18% |
| 21 | 4 | 4 | 510 | 8% |
| Untreated | 0 | 0 | 10 | “0” |

*Fluorine amount by AATCC Test Method #189. ppm = micrograms per gram.

The data in Table 6 shows that the copolymers used in the method of the present invention gave effective dry soil resistance when applied to carpeting even at levels as low at 130 ppm fluorine by weight of the carpet fiber.

### Example 26

Into a plastic beaker were combined 36.7 grams of deionized water, 2.0 grams of tridecanol-5EO (ETHAL TDA-5, which is a nonionic surfactant used to stabilize the emulsion, available from Ethox Chemicals, Greenville, S.C.), 7.1 grams of octadecylmethyl[polyoxyethylene (15)] ammonium chloride (ETHOQUAD 18/25, which is a cationic surfactant used to stabilize the emulsion, available from Akzo-Nobel, Chicago, Ill.), 0.6 grams of 7EO methacrylate (BLEMMER 350, as a co-monomer, available from NOF-America, White Plains, N.Y.), 5.2 grams of stearyl methacrylate, 0.6 grams of hydroxymethyl acrylamide, 0.3 grams of hydroxy ethyl methacrylate, 0.16 grams of dodecyl mercaptan, 8.6 grams of dipropylene glycol, and 24.4 grams of Monomer B prepared as previously described. The reaction mixture was heated to 55° C. and emulsified in a sonicator for two minutes until a uniform milky white emulsion resulted. The solution was charged to a 250 mL flask equipped a nitrogen blanket, condenser, overhead stirrer and temperature probe, set to nitrogen sparging, and stirred at 170 rpm. When the temperature had dropped below about 30° C. the flask was switched to nitrogen blanket and 1.8 grams of vinylidene chloride was added. The solution was stirred for 15 minutes. After 15 minutes 0.18 grams of VAZO-50 initiator (available from E. I. du Pont de Nemours and Company, Wilmington, Del.) in 6.77 grams of deionized water was added. The reaction mixture was then heated to 50° C. over 30 min. The solution was stirred for 8 hours at 50° C. After 8 hours, the solution was cooled to room temperature and 0.19 grams of SUPRALATE WAQE (available from Witco, Houston Tex.) in 21.25 grams of deionized water was added with stirring over 15 minutes. The solution was then filtered into a small necked bottle using gravity filtration through a milk filter.

The resulting copolymer dispersion was applied to 100% cotton fabric and a 35%/65% fabric blend of cotton/polyester using the pad bath (dipping) process of Test Method 1. The amount of fluorinated copolymer dispersion used in the pad bath was calculated to achieve a fluorine level on fabric of between 1500 and 2000 micrograms per gram fluorine by weight. About 10 g/L of blocked isocyanate was used in the pad bath. The blocked isocyanate used was HYDROPHOBOL XAN, available from Ciba Specialty Chemicals, High Point, N.C. An anti-wrinkle-resin was included at 70 g/L, PERMAFRESH EFC available from Omnova Solutions, Chester, S.C. After application, the fabrics were cured at about 160° C. for about 3 minutes. The fabric was allowed to “rest” after treatment and cure. The cotton fabric was tested for water repellency and oil repellency using Test Methods 2 and 3 as described above. The results are in Table 7.

### Example 27

The procedure of Example 26 was employed but 19.5 grams of Monomer A prepared as previously described was substituted for Monomer B in the emulsion copolymerization. The resulting copolymer dispersion was applied to 100% cotton fabric and a 35%/65% fabric blend of cotton/polyester using the pad bath (dipping) process of Test Method 1. The amount of fluorinated copolymer dispersion used in the pad bath was calculated to achieve a fluorine level on fabric of between 1500 and 2000 micrograms per gram fluorine by weight. About 10 g/L of blocked isocyanate was used in the pad bath. The blocked isocyanate used was HYDROPHOBOL XAN, available from Ciba Specialty Chemicals, High Point, N.C. An anti-wrinkle-resin was included at 70 g/L, PERMAFRESH EFC available from Omnova Solutions, Chester, S.C. After application, the fabrics were cured at about 160° C. for about 3 minutes. The fabric was allowed to “rest” after treatment and cure. The cotton fabric was tested for water repellency and oil repellency using Test Methods 2 and 3 as described above. The results are in Table 7.

### Example 28

The procedure of Example 26 was employed but 19.5 grams of Monomer C prepared as previously described was substituted for Monomer B in the emulsion copolymerization. The resulting copolymer dispersion was applied to 100% cotton fabric and a 35%/65% fabric blend of cotton/polyester using the pad bath (dipping) process of Test Method 1. The amount of fluorinated copolymer dispersion used in the pad bath was calculated to achieve a fluorine level on fabric of between 1500 and 2000 micrograms per gram fluorine by weight. About 10 g/L of blocked isocyanate was used in the pad bath. The blocked isocyanate used was HYDROPHOBOL XAN, available from Ciba Specialty Chemicals, High Point, N.C. An anti-wrinkle-resin was included at 70 g/L, PERMAFRESH EFC available from Omnova Solutions, Chester, S.C. After application, the fabrics were cured at about 160° C. for about 3 minutes. The fabric was allowed to “rest” after treatment and cure. The cotton fabric was tested for water repellency and oil repellency using Test Methods 2 and 3 as described above. The results are in Table 7.

TABLE 7
Repellency Performance Evaluation of Emulsion Copolymer

| | | | | | Measured |
|---|---|---|---|---|---|
| | | | | | weight |
| | Polyester/Cotton | | Cotton | | ratio of |
| | Oil | | Oil | | fluorine to |
| | Repel- | IPA/Water | Repel- | IPA/Water | fabric |
| Example | lency | Repellency | lency | Repellency | (ppm)* |
| 26 | 1 | 5 | 1 | 4 | 1640 |
| 27 | 4 | 8 | 4 | 5 | 1990 |
| 28 | 3 | 6 | 3 | 4 | 1520 |
| Untreated | 0 | 0 | 0 | 0 | |

*Fluorine amount by AATCC Test Method #189. ppm = micrograms per gram.

The data in Table 7 shows that copolymers used in the present invention prepared by emulsion copolymerization of fluorinated urethane(meth)acrylate monomers gave effective oil, water and alcohol repellency when applied to either polyester/cotton or 100% cotton textile fabrics.

What is claimed is:

1. A method of providing water repellency, alcohol repellency, oil repellency, and soil resistance to substrates comprising contacting said substrate with a composition comprising a copolymer having repeating units of Formula 1 in any sequence:
[R_{f}(CH₂)ₖOC(O)NH(CH₂)ₖOC(O)C(T)CH₂]ₘ—[W_{q}]ₚ— Formula 1
wherein
R_{f} is a straight or branched perfluoroalkyl group having from about 2 to about 8 carbon atoms, or a mixture thereof, which is optionally interrupted by at least one oxygen atom,
each k is independently a positive integer from 1 to about 6,
T is hydrogen or methyl,
m is a positive integer,
q is zero or a positive integer,
p is zero or a positive integer, and
W is 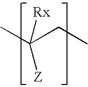
or 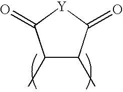
or —[R¹—X—Y—C(O)—CZ-CH₂]—,
wherein
X is an organic divalent linking group having from about 1 to about 20 carbon atoms, optionally containing a triazole, oxygen, nitrogen, or sulfur, or a combination thereof,
Y is O or N(R) wherein R is H or C₁ to C₂₀ alkyl,
Z is H, a straight or branched alkyl group having from about 1 to about 4 carbon atoms, or halide,
Rx is C(O)O(R¹), C(O)N(R²)₂, OC(O)(R¹), SO₂(R¹), C₆(R³)_{g}H_{(5-g)}, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to about 40,
R⁴ is H or CₛH₂ₛ₊₁,
s=0 to about 40,
i=1 to about 200,
each R² is independently H, or CₜH₂ₜ₊₁ wherein t is 1 to 20,
each R³ is independently R⁴, COOR¹, halogen, N(R¹)₂, OR¹, SO₂NHR¹, CH═CH₂, or SO₃M,
g is 1 to 5, and
M is H, alkali metal salt, alkaline earth metal salt, or ammonium.

2. The method of claim 1 wherein R_{f} has from about 4 to about 6 carbon atoms, or a mixture thereof.

3. The method of claim 1 wherein R_{f} has 6 carbon atoms.

4. The method of claim 1 wherein k is 2 and T is methyl.

5. The method of claim 1 wherein W is methacrylic acid, alkyl methacrylate ester, vinylidene chloride, and styrene.

6. The method of claim 1 wherein W is stearyl acrylate or stearyl methacrylate.

7. The method of claim 1 wherein the composition further comprises repeating units from optional monomers, said monomers selected from the group consisting of alkyl(meth)acrylates, N-methylol(meth)acrylates, hydroxyalkyl(meth)acrylates, alkyloxy(meth)acrylates, fluorinated(meth)acrylates, glycidyl(meth)acrylates, stearyl acrylate, aminoalkyl methacrylate hydrochloride, acrylamide, alkyl acrylamide, vinyl acetate, vinyl stearate, alkyl vinyl sulfone, styrene, vinyl benzoic acid, alkyl vinyl ether, maleic anhydride, vinylidene chloride, vinyl chloride, and olefin.

8. The method of claim 7 wherein the alkyl(meth)acrylates contain an alkyl group which is methyl, ethyl, propyl, butyl, isoamyl, hexyl, cyclohexyl, octyl, 2-ethylhexyl, decyl, isodecyl, lauryl, cetyl, or stearyl, preferably 2-ethylhexyl acrylate, lauryl acrylate and stearyl acrylate.

9. The method of claim 1 wherein the composition is applied as an aqueous dispersion or solution.

10. The method of claim 1 wherein the composition is applied by means of exhaustion, foam, flex-nip, nip, pad, kiss-roll, beck, skein, winch, liquid injection, overflow flood, roll, brush, roller, spray, dipping or immersion.

11. The method of claim 1 wherein the composition is applied in the presence of at least one of an agent which provides a surface effect which is no iron, easy to iron, shrinkage control, wrinkle free, permanent press, moisture control, softness, strength, anti-slip, antistatic, anti-snag, anti-pill, stain repellency, stain release, soil repellency, soil release, water repellency, oil repellency, odor control, antimicrobial, or sun protection, or a combination thereof.

12. The method of claim 1 wherein the composition is applied in the presence of at least one of a surfactant, antioxidant, light fastness agent, color fastness agent, water, pH adjuster, cross linker, wetting agent, extender, foaming agent, processing aid, lubricant, blocked isocyanate, nonfluorinated and extenders, or a combination thereof.

13. A substrate to which has been applied a composition comprising a copolymer having repeating units of Formula 1 in any sequence:
[R_{f}(CH₂)ₖOC(O)NH(CH₂)ₖOC(O)C(T)CH₂]ₘ—[W_{q}]ₚ— Formula 1
wherein
R_{f} is a straight or branched perfluoroalkyl group having from about 2 to about 8 carbon atoms, or a mixture thereof, which is optionally interrupted by at least one oxygen atom,
each k is independently a positive integer from 1 to about 6,
T is hydrogen or methyl,
m is a positive integer,
q is zero or a positive integer,
p is zero or a positive integer, and
W is 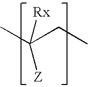
or 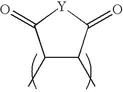
or —[R¹—X—Y—C(O)—CZ-CH₂]—,
wherein
X is an organic divalent linking group having from about 1 to about 20 carbon atoms, optionally containing a triazole, oxygen, nitrogen, or sulfur, or a combination thereof,
Y is O or N(R) wherein R is H or C₁ to C₂₀ alkyl,
Z is H, a straight or branched alkyl group having from about 1 to about 4 carbon atoms, or halide,
Rx is C(O)O(R¹), C(O)N(R²)₂, OC(O)(R¹), SO₂(R¹), C₆(R³)_{g}H_{(5-g)}, O(R¹), halide, or R¹;
each R¹ is independently H, CₙH₂ₙ₊₁, CₙH₂ₙ—CH(O)CH₂, [CH₂CH₂O]ᵢR⁴, [CₙC₂ₙ]N(R⁴)₂ or [CₙH₂ₙ]CₙF₂ₙ₊₁,
n is 1 to about 40,
R⁴ is H or CₛH₂ₛ₊₁,
s=0 to about 40,
i=1 to about 200,
each R² is independently H, or CₜH₂ₜ₊₁ wherein t is 1 to 20,
each R³ is independently R⁴, COOR¹, halogen, N(R¹)₂, OR¹, SO₂NHR¹, CH═CH₂, or SO₃M,
g is 1 to 5, and
M is H, alkali metal salt, alkaline earth metal salt, or ammonium,
said substrate having water repellency, alcohol repellency, oil repellency and soil resistance.

14. The substrate of claim 13 comprising a fibrous substrate.

15. The substrate of claim 13 which is a fiber, yarn, fabric, fabric blend, textile, spunlaced nonwoven, carpet, paper or leather.

16. The substrate of claim 13 which is selected from the group consisting of cotton, cellulose, wool, silk, rayon, nylon, aramid, acetate, acrylic, jute, sisal, sea grass, coir, polyamide, polyester, polyolefin, polyacrylonitrile, polypropylene, polyaramid, and blends thereof.

17. The substrate of claim 13 which has oil repellency and soil resistance.

18. The substrate of claim 17 which is a spunbonded-meltblown-spunbonded nonwoven.

19. The substrate of claim 18 which is a polypropylene.
